(19) United States
(12) Patent Application Publication
(10) Pub. No.: US 2015/0367277 A1
(43) Pub. Date: Dec. 24, 2015

(54) Alkanolamine-Based Carbon Dioxide Absorbent Containing Polyalkylene Glycol Monomethyl Ether, and Carbon Dioxide Absorption Method and Separation Method Using Same

(71) Applicant: UNIVERSITY-INDUSTRY COOPERATION FOUNDATION OF KYUNG HEE UNIVERSITY, Gyeonggi-do (KR)

(72) Inventors: Hoon Sik KIM, Seoul (KR); Minserk CHEONG, Seoul (KR); Jinkyu IM, Seoul (KR); Sung Yun HONG, Gyeonggi-do (KR)

(21) Appl. No.: 14/758,761

(22) PCT Filed: Dec. 27, 2013
(86) PCT No.: PCT/KR2013/012271

§ 371 Date: Jun. 30, 2015

(30) Foreign Application Priority Data
Dec. 31, 2012 (KR) 10-2012-0158448

(51) Int. Cl. B01D 53/14

(52) U.S. Cl. CPC B01D 53/1475; B01D 53/1493; B01D 2252/20484; B01D 2252/602

(57) ABSTRACT

The present invention relates to the use of an aqueous solution as a carbon dioxide absorbent, the aqueous solution containing a tertiary dialkylalkanolamine as a primary absorbent, a secondary alkanolamine as a rate enhancer, and polyalkylene glycol monomethyl ether as a regeneration promoter. The alkanolamine-based carbon dioxide absorbent containing polyalkylene glycol monomethyl ether and the carbon dioxide absorption method and separation method using same, according to the present invention, not only have an excellent carbon dioxide absorption capacity and a rapid carbon dioxide absorption rate, but also have a remarkably low absorbent regeneration temperature compared with a conventional alkanolamine-based absorbent and thus can significantly reduce the entire energy consumption required for an absorption process, and can also prevent recovered carbon dioxide from being contaminated with moisture and absorbent vapor, owing to the low regeneration temperature.

### TECHNICAL FIELD

The present invention relates to a method of using aqueous solutions containing dialkylalkanolamine, which is a tertiary amine, alkylalkanolamine, which is a secondary amine, and polyethylene glycol monomethylether as a carbon dioxide absorbent. More particularly, the present invention relates to an alkanolamine-based carbon dioxide absorbent containing polyalkylene glycol monomethyl ether and a carbon dioxide absorption method and separation method using the same, in which dialkylalkanolamine, which is a tertiary amine with a slow absorption rate and a high absorption capacity of carbon dioxide per mole, is used as a main absorbent, a linear secondary alkanolamine, which is not sterically hindered with a low absorption capacity of carbon dioxide per mole, a low regeneration efficiency, and a high carbon dioxide absorption rate, is used as a rate enhancer, and polyalkylene glycol monomethyl ether, which does not have a high carbon dioxide absorption capacity but is enabled to promote regeneration of alkanolamine, is used as a regeneration promoter.

### BACKGROUND

Various methods such as absorption, adsorption, membrane separation, and cryogenic separation are used to separate carbon dioxide from exhaust gas of chemical plants, power plants or large-sized boilers and from natural gas. An absorption or adsorption method is widely used when the concentration of exhausted carbon dioxide is low.

The method is widely used since it can be selectively separate particular gas that can be well absorbed or adsorbed into an absorbent or adsorbent; however, since the adsorbent or adsorbent is chemically altered during the separation, it is necessary to periodically replace the absorbent or adsorbent. On the other hand, an absorption method in which a liquid absorbent is used is widely used in purification of a large amount of exhaust gas or used in gas separation since it is easy to replace the absorbent and absorb a greater absorption capacity; however, the liquid absorbent may be chemically or thermally altered.

As a carbon dioxide absorbent, aqueous amine solution such as monoethanolamine (MEA), N-methyldiethanolamine (MEDA), diethanolamine (DEA), etc., are widely used. It is because, when reacting with carbon dioxide, an alkanolamine absorbent is chemically combined to thereby form carbamate compounds, and then, when heat is applied to the alkanolamine absorbent, the carbamate compounds are separated such that the carbon dioxide can be stripped and recovered and the alkanolamine absorbent can be regenerated. However, the process has some serious drawbacks in that: performance degradation may be caused by irreversible formation and decomposition of amine compounds due to impurities, such as sulfur dioxide (SO₂), oxygen (O₂), and nitrogen oxide (NOₓ), which are contained in a combustion exhaust gas, thereby causing corrosion of an absorption device; high thermal stability of carbamates formed by reaction with carbon dioxide requires a regeneration temperature to be 120° C. or higher, thereby causing excessive energy consumption (MEA requires 4.0 to 4.2 GJ per ton of carbon dioxide), excessive volatile loss of alkanolamine due to the high regeneration temperature (4 kg per ton in the case of using MEA), and replenishment of an absorbent. Carbon dioxide may be contaminated due to low vapor pressure of an absorbent during the regeneration process.

In order to resolve the drawbacks of the aqueous amine solutions, there have been reported various methods of physically absorbing carbon dioxide using organic solvents such as Selexol, IFPexol, NFM, etc. One important effect of the organic solvent absorbent is that there is required a lower energy to recover carbon dioxide and recycle solvents since the absorption of carbon dioxide is achieved by a physical interaction between the solvent and carbon dioxide, not by the chemical bond as in the case of the aqueous amine solutions. More specifically, in the case of using the amine absorbent, the recovery of carbon dioxide and the recycling of solvent require an energy-intensive high-temperature stripping process; by contrast, in the case of the physical absorption, it is possible to recover carbon dioxide dissolved in the solvent by simply changing the pressure, not by increasing the temperature.

The first problem is a low carbon dioxide absorption capacity. Since the organic solvent exhibits a carbon dioxide absorption capacity significantly lower than that of aqueous amine solutions, the circulation rate of the absorbent is high, thus necessitating a relatively larger equipment. Thus, the organic solvent absorbent is more suitable for purification of natural gas having high carbon dioxide pressure.

The second problem is a high circulation rate. Since the physical absorption process by the organic solvent requires an absorbent circulation rate generally twice higher than that of the aqueous amine solution, a larger capital and a higher equipment cost are required.

Thus, there have been demands for development of a new absorbent which has a high thermal and chemical stability and a lower vapor pressure in order to solve the drawbacks of the amine absorbent and the organic solvent absolvents.

Various attempts have been made to use as an absorbent a non-volatile ionic liquid having a high thermal stability and maintaining its liquid phase at low temperature below 100° C., as disclosed in U.S. Pat. No. 6,849,774 B2, U.S. Pat. No. 6,623,659 B2, and U.S. Patent Publication No. 2008/0146849 A1. The ionic liquid is a salt compound having a polarity and containing an organic cation and an organic or inorganic anion, and is capable of dissolving a gas molecular, such carbon monoxide, carbon dioxide, sulfur dioxide gas (SO₂), nitrous oxide (N₂O), and the like. The solubility of gas absorbed into the ionic liquid varies according to the degree of interaction between the gas and ionic liquid. Therefore, if the polarity, acidity, basicity, and nucleophilicity of the ionic liquid are changed by appropriately changing the cation and anion structures of the ionic liquid, it is possible to adjust the solubility of a specific gas to some extent.

Typically, an ionic liquids absorbent contain nitrogen-containing organic cations such as quatertiary ammonium including imidazolium, pyrazolium, triazolium, pyridinium, pyridazinium, and pyrimidinium, and anions such as halogens (e.g., Cr, Br⁻, and BF₄⁻, PF₆⁻, (CF₃SO)₂N⁻, CF₃SO₃⁻, MeSO₃⁻, NO₃⁻, CF₃CO₂⁻, and CH₃CO₂⁻. Especially, it is reported that an anion containing a fluorine atom has a relatively high carbon dioxide absorption capacity. However, the ionic liquid absorbents have problems that the carbon dioxide absorption capacity is significantly low compared to the amine absorbent, so it is not economically appropriate to use the ionic liquid absorbent in the process of capturing carbon dioxide from exhaust gas in a power plant. In particular, ionic liquids having anions containing fluorine atoms, such as tetrafluoroborate (BF₄⁻), hexafluorophosphate (PF₆⁻), and trifluoromethanesulphonylimide ((CF₃SO₂)2N⁻), are highly soluble in acid gases, such as carbon dioxide and carbon disulfide. However, synthesis for the ionic liquids usually requires a complicated manufacturing process of two or more stages and their manufacturing cost is very high, so that there are many challenges in industrially utilizing the ionic liquids. In addition, physical absorbents, such as organic solvents and ionic liquids, have a small carbon dioxide absorption capacity at low pressure and thus are not adequate for capturing carbon dioxide from combustion exhaust gas exhausted at atmospheric pressure.

Thus, a chemical absorbent has to be used to capture carbon dioxide from combustion exhaust gas. However, as mentioned in the above, an alkanolamine-based chemical absorbent, such as MEA, have various problems including excessive consumption of regeneration energy. Various attempts have been made to use alkanolamine having sterically hinderance around amine groups as an absorbent, and a typical example thereof is 2-amino-2-methyl-1-propanol (AMP), which is a secondary amine. When reacting with carbon dioxide, AMP forms bicarbonate compounds that may be regenerated more readily than carbamates, thereby requiring 30% less regeneration energy compared to MEA; however, its CO₂ absorption rate is less than 50% of the absorption rate of MEA.

As a method of increasing the absorption rate of AMP, Mitsubishi Heavy Industries, Ltd. and Kansai Electric Power Co., Inc. made a joint effort to develop a novel absorbent prepared by adding piperazine, which is a secondary cycloamine, to AMP (Japanese Patent No. 3197173). However, in the method, an excessive amount of piperazine is used such that precipitation occurs after absorbing carbon dioxide, and when piperazine is reacted with carbon dioxide, thermally stable carbamate compounds are formed in addition to bicarbonates, such that a regeneration process is difficult to perform. Furthermore, a boiling point of piperazines itself is low, so that loss of piperazines occurs during an absorbent regeneration process.

Further, there is also a known method of using, as a CO₂ absorbent, alkali carbonate, such as sodium carbonate or potassium carbonate, instead of using a primary alkanolamine absorbent. However, the method has a problem of low CO₂ absorption rate. As a method of increasing a CO₂ absorption rate, WO2004-089512 A1 discloses a method of adding piperazine or its derivative to potassium carbonate in which a CO₂ absorption rate of potassium carbonate is significantly increased by. However, the method also has a drawback in that precipitation occurs when using potassium carbonate.

### Technical Problem

The present invention is proposed to solve the above problem, and aims to an alkanolamine-based carbon dioxide absorbent containing polyalkylene glycol monomethyl ether and a carbon dioxide absorption method and separation method using the same, in which an absorption capacity is greater than existing alkanolamine-based and alkalicarbonate-based absorbents, regeneration temperature of absorbents is low. Energy consumption required for the process is reduced significantly due to high regeneration efficiency, and corrosion and loss of solvents are reduced due to low regeneration temperature.

The above and other purposes and advantages of the present invention will be more apparent from the following disclosure of preferred exemplary embodiments.

### Technical Solution

The above objective may be achieved by an alkanolamine-based carbon dioxide absorbent, wherein a tertiary dialkylalkanolamine represented by the following Formula 1 is used as a main absorbent. A secondary alkanolamine not sterically hindered and represented by the following Formula is used as a rate enhancer. Polyalkylene glycol monomethylether represented by the following Formula 3 is used as a regeneration promoter,

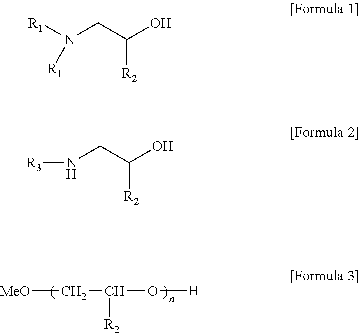

wherein R₁ denotes a C1 to C6 alkyl group or a cycloalkyl group, R₂ denotes hydrogen or a methyl group, and R₃ denotes a C1 to C6 alkyl group.

In addition, the above objective may be achieved by a carbon dioxide absorption method, wherein the alkanolamine-based carbon dioxide absorbent of any one of claims 1 to 4 is dissolved in water to absorb carbon dioxide.

The total amount of the alkanolamine-based carbon dioxide absorbent may be 20 to 100% by weight with respect to 100 weight of water.

The amount of the main absorbent in the alkanolamine-based carbon dioxide absorbent may be 15 to 80% by weight with respect to 100 weight of water.

Preferably, the amount of the rate enhancer in the alkanolamine-based carbon dioxide absorbent is 15 to 100% by weight with respect to 100 weight of the main absorbent.

The an amount of the regeneration promoter in the alkanolamine-based carbon dioxide absorbent may be 10 to 100% by weight with respect to 100 weight of the main absorbent.

In addition, the above objective may be achieved by a carbon dioxide separation method, including: a first step in which the alkanolamine-based carbon dioxide absorbent of any one of claims 1 to 4 is used to absorb carbon dioxide from gas mixtures containing carbon dioxide; and a second step in which the absorbed carbon dioxide is desorbed from the alkanolamine-based carbon dioxide absorbent.

Temperature of the absorption in the first step may be 10° C. to 60° C.

Pressure of the absorption in the first step may be normal pressure to 30 atmosphere (atm).

Temperature of the desorption in the second step may be 70° C. to 140° C.

Pressure of the desorption in the second step may be normal pressure.

Additional features of the invention will be set forth in the description which follows, and in part will be apparent from the description, or may be learned by practice of the invention.

### Advantageous Effects

The present invention has effects of not only having an excellent carbon dioxide absorption capacity and a rapid absorption rate, but also having a remarkably low absorbent regeneration temperature compared with a conventional absorbent and thus significantly reducing the entire energy consumption required for an absorption process, and maintaining initial absorption capability so that it can be used as an excellent carbon dioxide separation media even when absorption and desorption of carbon dioxide are repeated.

### DRAWINGS

FIG. 1 is a schematic diagram illustrating a carbon dioxide absorption and desorption test device.

### MODE FOR INVENTION

The present invention is described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art.

Inventors of the present invention have studied examples of mechanisms for absorption and regeneration of alkanolamine, and found out that a mechanism for regeneration is not simply reverse of an alkanolamine absorption pathway, but is more complex. For example, in the case of the primary amines absorbent, carbamate or bicarbonate is formed by absorbing alkanolamine, while carbamate compounds, whose decomposition is inevitably difficult, are formed by regenerating alkanolamine.

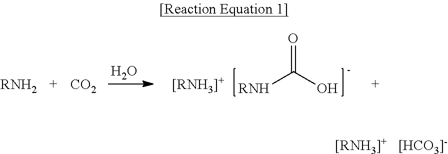

In addition, the inventors of the present invention have conducted an investigation on a mechanism for regeneration of carbamate compounds, and found that regeneration of carbamate compounds starts from removing H⁺ from ammonium cations and that carbamate may be regenerated easier when there is polyalkylene glycol monomethyl ether, that is, polyethylene glycol monomethyl ether or polyalkylene propylene glycol monomethyl ether, which has a plurality of ether groups enabled to react with H atom of an ammonium cation and a hydroxyl group enabled to react with a carbamate anion.

An alkanolamine-based carbon dioxide absorbent according to the present invention uses tertiary dialkylalkanolamine, represented by the following Formula 1, as a main absorbent, a secondary alkanolamine, which is not sterically hindered and represented by the following Formula 2, as a rate enhancer, and polyalkylene glycol monomethylether, represented by the following Formula 3, as a regeneration promoter, thereby dramatically reducing energy consumption required for an absorbent regeneration processing, compared to existing alkanolamine-based and alkalicarbonate-based absorbent.

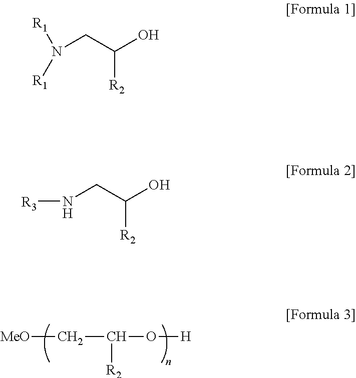

In Formulas 1 to 3, R₁ denotes a C₁ to C₆ alkyl group or a cycloalkyl group, R₂ denotes hydrogen or a methyl group, and R₃ denotes a C₁ to C₆ alkyl group.

The C₁ to C₆ alkyl group denoted as R₁ in Formula 1 indicates a linear or branched alkyl group having 1 to 6 Carbon atoms. Examples of the C₁ to C₆ alkyl group include methyl, ethyl, propyl, isopropyl, n-butyl, isobutyl, n-amyl, i-amyl, n-hexyl, 2-hexyl, and the like, but are not limited thereto. In addition, examples of the cycloalkyl group denoted as R₁ in Formula 1 includes cyclopentyl, cyclohexyl, and the like, but are not limited thereto.

The alkyl group denoted as R₂ in Formula 1 and Formula 2 is hydrogen or a methyl group.

Examples of the C₁ to C₆ alkyl group denoted as R₃ in Formula 2 include methyl, ethyl, n-propyl, n-butyl, n-pentyl, n-hexyl, and the like, but are not limited thereto.

Examples of tertiary dialkylamine, which is represented by Formula 1 and used as a main absorbent, include 2-(demethylamino)ethanol, 1-methyl-2-(demethylamino)ethanol, 2-(demethylamino)ethanol, 1-methyl-2-(diethylamino)ethanol, 2-(dipropylamino)ethanol, 1-methyl-2-(dipropylamino)ethanol, 2-(diisopropylamino)ethanol, 1-methyl-2-(diisopropylamino)ethanol, 2-(diethylamino)ethanol, 1-methyl-2-(diethylamino)ethanol, 2-(diisobutylamino)ethanol, 1-methyl-2-(diisobutylamino)ethanol, 2-(di-n-amylamino)ethanol, 1-methyl-2-(di-n-amylamino)ethanol, 2-(diisoamylamino)ethanol, 1-methyl-2-(diisoamylamino)ethanol, 2-(dihexylamino)ethanol, 1-methyl-2-(dihexylamino)ethanol, 2-(di-2-hexylamino)ethanol, 1-methyl-2-(di-2-hexylamylamino)ethanol, 2-(dicyclohexylamino)ethanol, and 1-methyl-2-(dicyclohexylamino)ethanol, but are not limited thereto.

In addition, examples of the secondary alkanolamine, represented by Formula 2 and used as a rate enhancer, include 2-(methylamino)ethanol, 1-methyl-2-(methylamino)ethanol, 1-ethyl-2-(methylamino)ethanol, 2-(ethylamino)ethanol, 1-methyl-2-(ethylamino)ethanol, 1-ethyl-2-(ethylamino)ethanol, 2-(butylamino)ethanol, 1-methyl-2-(butylamino)ethanol, 1-ethyl-2-(butylamino)ethanol, 2-(pentylamino)ethanol, 1-methyl-2-(pentylamino)ethanol, 1-ethyl-2-(pentylamino)ethanol, 2-(hexylamino)ethanol, 1-methyl-2-(hexylamino)ethanol, and 1-ethyl-2-(hexylamino)ethanol, but are not limited thereto.

In addition, polyalkylene glycol monomethylether (MPAG), such as polyethylene glycol monomethylether (MPEG) or polypropylene glycol monomethylether (MPPG), which is represented by Formula 3 and used as a regeneration promoter, is alkylenglyco monomethyl ether polymer with molecular weight 160 to 1000. Examples of the alkylenglyco monomethyl ether polymer includes triethylene glycol monomethyl ether, tripropylene glycol monomethyl ether, tetraethylene glycol monomethyl ether, tetrapropylene glycol monomethyl ether, pentaethylene glycol monomethyl ether, pentapropylene glycol monomethyl ether, hexaethylene glycol monomethyl ether, hexapropylene glycol monomethyl ether, heptaethylene glycol monomethyl ether, heptaethylene glycol monomethyl ether, octaethylene glycol monomethyl ether, octapropylene glycol monomethyl ether, nonaethylene glycol monomethyl ether, nonapropylene glycol monomethyl ether, decaethylene glycol monomethyl ether, decapropylene glycol monomethyl ether, dodecaethylene glycol monomethyl ether, dodecapropylene glycol monomethyl ether, hexadecaethylene glycol monomethyl ether, hexadecapropylene glycol monomethyl ether, heptaethylene glycol monomethyl ether, polyethylenegoycol monomethylether 200, polyethylenegoycol monomethylether 350, polyethylenegoycol monomethylether 450, polyethylenegoycol monomethylether 600, and polyethylenegoycol monomethylether 1000, but are not limited thereto.

In addition, the polyalkylene glycol monomethyl ether and the alkanolamine-based carbon dioxide absorbent containing secondary and tertiary alkanolamines according to the present invention are able to absorb carbon dioxide even without a solvent; however, considering an absorption capacity and viscosity of an absorbent, it is preferable that the alkanolamine-based carbon dioxide absorbent dissolved in water is used to absorb carbon dioxide.

In addition, the total amount of an absorbent containing the polyalkylene glycol monomethyl ether is preferably 10 to 150% by weight and, more preferably 20 to 100% by weight, with respect to 100 weight of water. If the amount of the polyalkylene glycol monomethyl ether and alkanolamine is less than 20% by weight with respect to water, a carbon dioxide absorption capacity is drastically reduced. On the other hand, if the amount of the polyalkylene glycol monomethyl ether and alkanolamine is over 100% by weight with respect to water, an increase in the carbon dioxide absorption rate and the amount of carbon dioxide absorbed is slight, but an absorbent liquid is too viscous.

In addition, the amount of the main absorbent represented by the above Formula 1 is preferably 15 to 80% by weight and, more preferably 20 to 60% by weight, with respect to 100 weight of water. If the amount of the main absorbent A is less than 20% by weight with respect to water, the advantage of the tertiary absorbent is reduced, while the carbon dioxide absorption rate is drastically reduced if the amount of the main absorbent A is over 60% by weight with respect to water.

In addition, the amount of the rate enhancer represented by the above Formula 2 is preferably 15 to 100% by weight and, more preferably 25 to 70% by weight, with respect to 100 weight of the main absorbent. If the amount of the rate enhancer is less than 15% by weight with respect to the main absorbent, an increase in the carbon dioxide absorption rate is slight, while there is only a slight increase in the amount of carbon dioxide absorbed but too much energy is consumed during regeneration if the amount of the rate enhancer is over 100% by weight with respect to the main absorbent.

Next, the amount of the regeneration promoter represented by the above Formula 3 is preferably 10 to 100% by weight and, more preferably 15 to 75% by weight, with respect to 100 weight of the main absorbent. If the amount of the regeneration promoter is less than 10% by weight with respect to the main absorbent, there are only slight effects of the absorbent regeneration. If the amount of the regeneration promoter is over 100% by weight with respect to the main absorbent, effects of the absorbent regeneration improve but the absorbent becomes more viscous, thereby reducing the amount of carbon dioxide absorbed and the absorption rate.

In addition, in the composition of a tertiary carbon dioxide absorbent according to the present invention, the rate enhancer, which is a secondary amine not sterically hindered, enhances an absorption rate; however, when reacting with carbon dioxide, it generates not only bicarbonate, but also carbamate compounds, which has a great thermal stability and is hard to be regenerated, as shown in the following Reaction Equation 2.

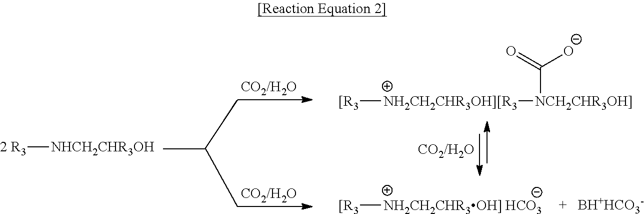

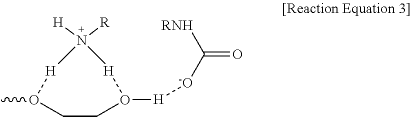

Thus, by using the absorbent according to the present disclosure, it is possible not only to regenerate the absorbent at low temperature and thus reduce energy consumption required for the whole absorption process, but to avoid corrosion and loss of the absorbent, which may occur at high regeneration temperature.

In addition, the carbon dioxide separation method according to the present invention, in which carbon dioxide is separated by the aforementioned carbon dioxide absorbent from gas mixtures containing carbon dioxide, includes the first step, where an aqueous solution (a tertiary alkanolamine solution), which are the alkanolamine-based carbon dioxide absorbent dissolved in water, absorbs carbon dioxide, and the second step where the absorbed carbon dioxide is desorbed from the carbon dioxide absorbent.

Examples of the gas mixtures containing carbon dioxide includes exhaust gas of chemical plants, power plants or large-sized boilers, and natural gas.

In addition, the preferable absorption temperature when carbon dioxide is absorbed in the first step is in a range between 10° C. and 60° C. and, more preferably, a range between 30° C. and 50° C. In addition, the preferable pressure is in a range of 50 atm and, more preferably, normal pressure or a range of 30 atm. If the absorption temperature is over 60° C., desorption is performed simultaneously, thereby reducing the amount of carbon dioxide absorbed. If the absorption temperature is less than 10° C., a refrigeration equipment is required to reduce temperature, thereby causing economic inefficiency. Furthermore, as the pressure of exhaust gas is normal pressure, it is most economical to absorb carbon dioxide at normal pressure, and, if the absorption pressure is over 50 atm, the amount of carbon dioxide absorbed dramatically increases but additional equipment, e.g., a compressor, is required to increase pressure, thereby causing economic inefficiency.

In addition, the temperature preferred when the absorbed carbon dioxide is desorbed in the second step is 70° C. to 140° C. and, more preferably, 80° C. to 120° C., and the preferable temperature is normal pressure. If the desorption temperature is less than 70° C., desorption is not performed. If the desorption temperature is over 140° C., it becomes the same case as that of using an MEA absorbent, thereby removing the advantage of the tertiary absorbent according to the present invention. Furthermore, it is difficult to perform desorption at high pressure, because the vapor pressure of water needs to be high and it inevitably requires high temperature, thereby causing economic inefficiency. Thus, it is desirable to perform desorption at normal pressure.

The term “normal pressure” used in the present invention refers to “atmospheric pressure”, i.e., 1 atm.

Hereinafter, the configuration and effect of the present invention are described in detail with reference to examples and a comparative example. However, the exemplary embodiments are to specifically describe the present invention, but the scope of the present invention is not limited thereto.

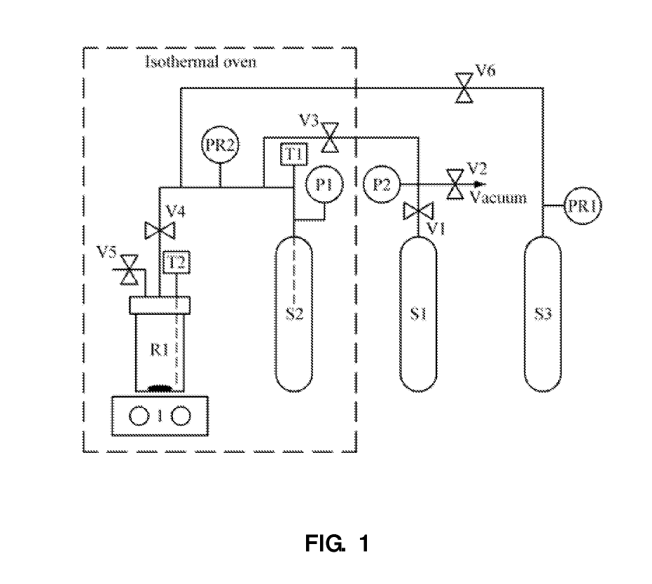

First, a carbon dioxide absorption/desorption capacity test is conducted using a carbon dioxide absorption/desorption capacity tester shown in FIG. 1. The carbon dioxide absorption/desorption capacity tester includes a 60 ml stainless steel absorption reactor R1 equipped with a thermometer T2, a high-pressure transducer P1 (0 to 1,500 psi), a 75 ml CO₂ storage cylinder S2 equipped with a thermometer T1, and a stirrer 1, and is installed in an isothermal oven to measure the carbon dioxide absorption/desorption capacities at a constant temperature. In addition, a carbon dioxide supply cylinder S1 and a manometer P2 are installed outside of the isothermal oven.

A specific amount of an absorbent has put the stainless steel absorption reactor R1 of FIG. 1 together with a magnet bar. After weighing, the stainless steel absorption reactor R1 was stirred at 60° C. for one hour, and dried under vacuum. Then, the temperature was reduced again to 40° C. to keep the reactor and the isothermal oven at a constant temperature. After turning off a valve V4 connected to the stainless steel absorption reactor R1, carbon dioxide at a constant pressure (e.g., 10 to 50 psig) was put into the CO₂ storage cylinder S2. Then, after the CO₂ storage cylinder S2 was maintained in equilibrium, the pressure and temperature were recorded. After stopping to be stirred, the stainless steel absorption reactor R1 was maintained at a constant pressure using the valve V4 and a pressure regulator. After the CO₂ storage cylinder S2 maintained in equilibrium, the pressure and temperature were recorded, and the CO₂ storage cylinder S2 was stirred. After one hour, the final pressure and temperature were recorded (equilibrium values), and a change in weight of the stainless steel absorption reactor R1 was measured.

In addition, during desorption test, the valve V4 was turned off and the pressure was increased to 70° C. to 120° C. Then, the valve V4, a value V5, and a value V6 were turned on, and nitrogen 20 mL/min was supplied to the stainless steel absorption reactor R1, thus desorbing the absorbed carbon dioxide. Then, the temperature is reduced to room temperature and a change in weight of the stainless steel absorption reactor R1 before and after the desorption was measured.

### Examples 1-8

A carbon dioxide absorption test was conducted by filling a 30 g solution, where a tertiary absorbent mixture containing 60% by weight of main absorbent A, 20% by weight of rate enhancer B, and 20% by weight of regeneration promoter is dissolved, with the absorption reactor R1, and maintaining temperature of the isothermal oven at 40° C. After stopping to be stirred, the absorption reactor R1 was maintained at pressure 1 atm. Then, after the CO₂ storage cylinder S2 was maintained in equilibrium, the pressure was recorded and the absorption reactor R1 was stirred again. After one hour, the final pressure and temperature were recorded, and the amounts of carbon dioxide absorbed per mole of amine were measured from difference between the initial pressure and temperature and the final pressure and temperature. In addition, for accuracy of the measurement, a change in weight of the absorption reactor R1 before and after carbon dioxide absorption was measured, and the results of carbon dioxide absorption tests are shown in Table 1:

TABLE 1

| | | | | CO₂ absorption |
|---|---|---|---|---|
| | Composition of tertiary absorbent | | | capacity |
| | | | C | (mol CO₂/mol |
| Example | A | B | (molecular weight) | amine) |
| 1 | 2- | 2- | triethylene glycol | 1.01 |
| | (diethylamino)ethanol | (butylamino)ethanol | monomethyl ether | |
| 2 | 1-methyl-2- | 1-methyl-2- | tripropylene glycol | 1.04 |
| | (diethylamino)ethanol | (methylamino)ethanol | monomethyl ether | |
| 3 | 2- | 1-methyl-2- | tetrapropylene | 0.98 |
| | (diisopropylamino) | (butylamino)ethanol | glycol monomethyl | |
| | ethanol | | ether | |
| 4 | 1-methyl-2- | 2- | tetraethylene glycol | 1.00 |
| | (diisopropylamino) | (pentylamino)ethanol | monomethyl ether | |
| | ethanol | | | |
| 4 | 2- | 2- | MPEG(350) | 0.92 |
| | (dibutylamino)ethanol | (hexylamino)ethanol | | |
| 5 | 2-(di-n- | 2- | MPEG(450) | 0.97 |
| | amylamino)ethanol | (butylamino)ethanol | | |
| 6 | 2- | 1-ethyl-2- | MPEG(600) | 0.95 |
| | (dihexylamino)ethanol | (methylamino)ethanol | | |
| 7 | 1-methyl-2-(di-2- | 1-methyl-2- | MPEG(750) | 0.93 |
| | hexylamylamino)ethanol | (propylamino)ethanol | | |
| 8 | 2- | 2- | MPEG(1000) | 0.92 |
| | (dicyclohexylamino)ethanol | (ethylamino)ethanol | | |

* MPEG: polyethylene glycol monomethyl ether

### Examples 9-12

Carbon dioxide absorption tests were performed in a manner, the same as Example 1, in which the same tertiary absorbent was used, the pressure was fixed at 1 atm, and the absorption temperature was changed. The results of the carbon dioxide absorption tests are shown in Table 2:

TABLE 2

| | Absorption | CO₂ absorption capacity |
|---|---|---|
| Example | temperature (° C.) | (mol CO₂/mol amine) |
| 9 | 10 | 1.23 |
| 10 | 30 | 1.14 |
| 11 | 50 | 0.75 |
| 12 | 60 | 0.61 |

### Examples 13-17

Carbon dioxide absorption tests were performed in a manner, the same as Example 1, in which the same absorbent of Example 1 was used, the temperature was fixed at 40° C., and the absorption pressure was changed. The results of the carbon dioxide absorption tests are shown in Table 3:

TABLE 3

| | Absorption | CO₂ absorption capacity |
|---|---|---|
| Example | pressure (atm) | (mol CO₂/mol amine) |
| 13 | 2 | 1.17 |
| 14 | 5 | 1.29 |
| 15 | 10 | 1.36 |
| 16 | 30 | 1.47 |
| 17 | 50 | 1.52 |

### Examples 18-23

Carbon dioxide absorption tests were performed in a manner, the same as Example 1, in which the same absorbent used in Example 1 was used, the temperature was fixed at 40° C., the pressure was fixed at 1 atm, and the total amounts of the tertiary absorbent in water was changed. The results of the carbon dioxide absorption tests are shown in the following Table 4. It is considered that the fact that, if the amounts of amine increases, the amounts of carbon dioxide absorbed per mole of amine is reduced is led by the fact that, if the amounts of amine increases, absorbent solution becomes more viscous and material delivery is therefore hindered.

TABLE 4

| | Amine/Water | CO₂ absorption capacity |
|---|---|---|
| Example | (% by weight) | (mol CO₂/mol amine) |
| 18 | 20 | 1.15 |
| 19 | 30 | 1.06 |
| 20 | 60 | 0.89 |
| 21 | 80 | 0.86 |
| 22 | 100 | 0.84 |
| 23 | 150 | 0.81 |

### Examples 24-32

Carbon dioxide absorption tests were performed in a manner, the same as Example 1, in which the same tertiary absorbent used in Example 1 was used, the absorption temperature was fixed at 40° C., the absorption pressure was fixed at 1 atm, the total amounts of the tertiary absorbent in water was fixed at 40 wt %, and the composition (wt %) of the main absorbent A, the rate enhancer B and the regeneration promoter C was changed. The results of the carbon dioxide absorption tests are shown in Table 5:

TABLE 5

| | | | | CO₂ | CO₂ absorption |
|---|---|---|---|---|---|
| | | | | absorption | speed for the first |
| | Composition of tertiary | | | capacity | ten minutes |
| | absorbent (wt %) | | | (mol CO₂/mol | (g CO₂/Kg |
| Example | A | B | C | amine) | absorbent-min) |
| 24 | 80 | 12 | 8 | 1.10 | 92.7 |
| 25 | 75 | 15 | 10 | 1.05 | 96.5 |
| 26 | 70 | 20 | 10 | 1.04 | 106.6 |
| 27 | 65 | 15 | 20 | 0.96 | 103.7 |
| 28 | 60 | 20 | 20 | 0.95 | 100.5 |
| 29 | 60 | 25 | 15 | 0.91 | 103.5 |
| 30 | 50 | 25 | 25 | 0.90 | 98.1 |
| 31 | 45 | 45 | 20 | 0.84 | 107.1 |
| 32 | 30 | 15 | 30 | 0.91 | 96.4 |

### Examples 33-41

Carbon dioxide desorption tests were performed in a manner, the same as Example 1, in which the absorption temperature was fixed at 40° C., the absorption pressure was fixed at 1 atm, composition of the tertiary absorbent, used in Example 1, was changed, the amount of carbon dioxide absorbed was measured, the pressure was reduced to room temperature, and nitrogen was introduced at 15 mL/min. Upon completion of the first absorption and desorption of carbon dioxide, the carbon dioxide absorption and desorption processes were repeated under the same conditions five times, the initial amounts of carbon dioxide absorbed and the final amounts of carbon dioxide absorbed were compared, and the result of the comparison is shown in Table 6:

TABLE 6

| | Composition of | | | CO₂ abortion capacity | | |
|---|---|---|---|---|---|---|
| | Tertiary absorbent | | | (mol CO₂/mol amine) | | Desorption |
| | (wt %) | | | First | Fifth | temperature |
| Examples | A | B | C | absorption | absorption | (° C.) |
| 33 | 80 | 12 | 8 | 1.10 | 1.09 | 140 |
| 34 | 75 | 15 | 10 | 1.05 | 1.04 | 120 |
| 35 | 70 | 20 | 10 | 1.04 | 0.96 | 100 |
| 36 | 65 | 15 | 20 | 0.96 | 0.95 | 100 |
| 37 | 60 | 20 | 20 | 0.95 | 0.93 | 100 |
| 38 | 60 | 25 | 15 | 0.93 | 0.91 | 100 |
| 39 | 50 | 25 | 25 | 0.90 | 0.75 | 90 |
| 40 | 45 | 45 | 20 | 0.84 | 0.71 | 80 |
| 41 | 30 | 15 | 30 | 0.91 | 0.67 | 70 |

### Comparative Example

A carbon dioxide desorption test was performed five times in a manner, similar to Example 33, in which an aqueous solution containing 30% by weight monoethanolamine was used as an absorbent and carbon dioxide was absorbed at 1 atm and 40° C. While 0.62 mol of carbon dioxide per mole of monoethanolamine was absorbed during the first absorption, 0.21 mol of carbon dioxide per mole of monoethanolamine was absorbed during the fifth absorption, and thus it was found that a conclusion that an absorption capacity of a solvent was reduced by about 66.1%.

The embodiments provided throughout the present disclosure are only some of various examples performed by the inventors of the present invention. However, the present invention should not be construed as limited to the embodiments set forth herein. It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. An alkanolamine-based carbon dioxide absorbent, wherein a tertiary dialkylalkanolamine represented by Formula 1 is used as a main absorbent, a secondary alkanolamine not sterically hindered and represented by Formula 2 is used as a rate enhancer, and polyalkylene glycol monomethylether represented by Formula 3 is used as a regeneration promoter, 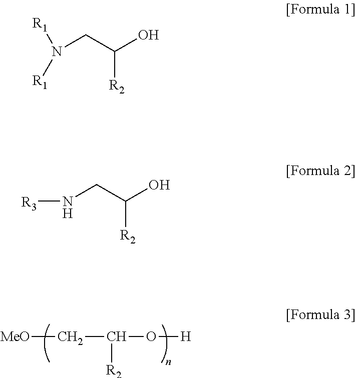
wherein R₁ denotes a C1 to C6 alkyl group or a cycloalkyl group, R₂ denotes hydrogen or a methyl group, and R₃ denotes a C1 to C6 alkyl group.

2. The alkanolamine-based carbon dioxide absorbent of claim 1, wherein the tertiary dialkylalkanolamine represented by Formula 1 and used as the main absorbent is at least one selected from a group consisting of 2-(demethylamino)ethanol, 1-methyl-2-(demethylamino)ethanol, 2-(demethylamino)ethanol, 1-methyl-2-(diethylamino)ethanol, 2-(dipropylamino)ethanol, 1-methyl-2-(dipropylamino)ethanol, 2-(diisopropylamino)ethanol, 1-methyl-2-(diisopropylamino)ethanol, 2-(diethylamino)ethanol, 1-methyl-2-(diethylamino)ethanol, 2-(diisobutylamino)ethanol, 1-metyl-2-(diisobutylamino)ethanol, 2-(di-n-amylamino)ethanol, 1-methyl-2-(di-n-amylamino)ethanol, 2-(diisoamylamino)ethanol, 1-methyl-2-(diisoamylamino)ethanol, 2-(dihexylamino)ethanol, 1-methyl-2-(dihexylamino)ethanol, 2-(di-2-hexylamino)ethanol, 1-methyl-2-(di-2-hexylamylamino)ethanol, 2-(dicyclohexylamino)ethanol, and 1-methyl-2-(dicyclohexylamino)ethanol.

3. The alkanolamine-based carbon dioxide absorbent of claim 1, wherein the secondary alkanolamine represented by Formula 2 and used as the rate enhancer is at least one selected from a group consisting of 2-(methylamino)ethanol, 1-methyl-2-(methylamino)ethanol, 1-ethyl-2-(methylamino)ethanol, 2-(ethylamino)ethanol, 1-methyl-2-(ethylamino)ethanol, 1-ethyl-2-(ethylamino)ethanol, 2-(butylamino)ethanol, 1-methyl-2-(butylamino)ethanol, 1-ethyl-2-(butylamino)ethanol, 2-(pentylamino)ethanol, 1-methyl-2-(pentylamino)ethanol, 1-ethyl-2-(pentylamino)ethanol, 2-(hexylamino)ethanol, 1-methyl-2-(hexylamino)ethanol, and 1-ethyl-2-(hexylamino)ethanol.

4. The alkanolamine-based carbon dioxide absorbent of claim 1, wherein the polyalkylene glycol monomethylether represented by Formula 3 and used as the regeneration promoter is polyethylene glycol monomethylether (MPEG) or polypropylene glycol monomethylether (MPPG), and is at least one having molecular weight 160 to 1000 and selected from a group consisting of triethylene glycol monomethyl ether, tripropylene glycol monomethyl ether, tetraethylene glycol monomethyl ether, tetrapropylene glycol monomethyl ether, pentaethylene glycol monomethyl ether, pentapropylene glycol monomethyl ether, hexaethylene glycol monomethyl ether, hexapropylene glycol monomethyl ether, heptaethylene glycol monomethyl ether, heptaethylene glycol monomethyl ether, octaethylene glycol monomethyl ether, octapropylene glycol monomethyl ether, nonaethylene glycol monomethyl ether, nonapropylene glycol monomethyl ether, decaethylene glycol monomethyl ether, decapropylene glycol monomethyl ether, dodecaethylene glycol monomethyl ether, dodecapropylene glycol monomethyl ether, hexadecaethylene glycol monomethyl ether, hexadecapropylene glycol monomethyl ether, heptaethylene glycol monomethyl ether, polyethylenegoycol monomethylether 200, polyethylenegoycol monomethylether 350, polyethylenegoycol monomethylether 450, polyethylenegoycol monomethylether 600, and polyethylenegoycol monomethylether 1000.

5. A carbon dioxide absorption method, wherein the alkanolamine-based carbon dioxide absorbent of claim 1 is dissolved in water to absorb carbon dioxide.

6. The carbon dioxide absorption method of claim 5, wherein a total amount of the alkanolamine-based carbon dioxide absorbent is 20 to 100% by weight with respect to 100 weight of water.

7. The carbon dioxide absorption method of claim 5, wherein an amount of the main absorbent in the alkanolamine-based carbon dioxide absorbent is 15 to 80% by weight with respect to 100 weight of water.

8. The carbon dioxide absorption method of claim 5, wherein an amount of the rate enhancer in the alkanolamine-based carbon dioxide absorbent is 15 to 100% by weight with respect to 100 weight of the main absorbent.

9. The carbon dioxide absorption method of claim 5, wherein an amount of the regeneration promoter in the alkanolamine-based carbon dioxide absorbent is 10 to 100% by weight with respect to 100 weight of the main absorbent.

10. A carbon dioxide separation method, comprising:
a first step in which the alkanolamine-based carbon dioxide absorbent of claim 1 is used to absorb carbon dioxide from gas mixtures containing carbon dioxide; and
a second step in which the absorbed carbon dioxide is desorbed from the alkanolamine-based carbon dioxide absorbent.

11. The carbon dioxide desorption method of claim 10, wherein temperature of the absorption in the first step is 10° C. to 60° C.

12. The carbon dioxide desorption method of claim 10, wherein pressure of the absorption in the first step is normal pressure to 30 atmosphere (atm).

13. The carbon dioxide separation method of claim 10, wherein temperature of the desorption in the second step is 70° C. to 140° C.

14. The carbon dioxide separation method of claim 10, wherein pressure of the desorption in the second step is normal pressure.
